(19) United States
(12) Patent Application Publication
(10) Pub. No.: US 2010/0065980 A1
(43) Pub. Date: Mar. 18, 2010

(54) METHOD FOR PRODUCING A THERMOPLASTIC RESIN MOLDED ARTICLE

(76) Inventor: Satoshi Hanada, Tokushima (JP)

Correspondence Address: FITCH, EVEN, TABIN & FLANNERY, P. O. BOX 18415, WASHINGTON, DC, 20036, US

(21) Appl. No.: 12/524,622

(22) PCT Filed: Jan. 29, 2008
(86) PCT No.: PCT/JP2008/051704

§ 371 Date: Nov. 17, 2009

(30) Foreign Application Priority Data
Jan. 30, 2007 (JP) 2007-018995

(51) Int. Cl. B29C 67/20

(52) U.S. Cl. 264/46.4

(57) ABSTRACT

A method for producing a thermoplastic resin molded article having a thermoplastic resin foam substrate and a functional member joined by welding to the foam substrate is provided. In order to prevent the occurrence of dimples on the surface of the molded article at the joined portion of the functional member, the molding of the functional member is performed while a pressure-resistant sheet is placed at an extended portion of a molten resin feeding gate provided at the bottom of a cavity for forming the functional member.

### TECHNICAL FIELD

The present invention relates to a method for producing a thermoplastic resin molded article comprising a foam substrate made of a first thermoplastic resin and a functional member made of a second thermoplastic resin which has been joined by welding to the foam substrate so as to project from the foam substrate. More specifically, it relates to a method for producing a thermoplastic resin molded article comprising a foam substrate made of a first thermoplastic resin and a functional member made of a second thermoplastic resin which has been joined by welding to the foam substrate so as to project from the foam substrate.

### BACKGROUND ART

Expansion molded articles produced by molding thermoplastic resin foam sheets are used for various applications, such as automotive components and building materials, because they are excellent in lightweight property, recyclability, thermal insulating properties, etc. Thermoplastic resin molded articles in which nonexpanded functional members, such as ribs, bosses and hooks, made of a thermoplastic resin have been joined by welding to such expansion molded articles can also be used as automotive interior components, etc. As a method for producing the aforementioned thermoplastic resin molded article, a method including the following steps (1) to (4) is known (see, for example, JP 2001-121561 A):

(1) a step of supplying a foam sheet made of a thermoplastic resin to between a pair of molds, at least one of which has a recess with a shape of a functional member;

(2) a step of closing the molds, thereby shaping the thermoplastic resin foam sheet and simultaneously closing the opening of the recess with the thermoplastic resin foam sheet;

(3) a step of supplying a thermoplastic resin in a molten state into the recess through a resin passage provided in a mold so as to lead to the recess, thereby joining the thermoplastic resin and the thermoplastic resin foam sheet together by welding to form the aforementioned thermoplastic resin molded article while maintaining the molds closed and the opening of the recess closed with the thermoplastic resin foam sheet;

(4) a step of cooling the thermoplastic resin molded article formed in the step (3) and taking it out of the molds.

### DISCLOSURE OF THE INVENTION

As to thermoplastic resin molded articles produced by the method described above, a depression (3) called a “dimple” may be formed on a surface of a thermoplastic resin molded article (2), the surface corresponding to a portion at which a functional member (1) like that shown in FIG. 1 has been formed.

The present invention provides a method for producing a thermoplastic resin molded article comprising a foam substrate made of a first thermoplastic resin and a functional member made of a second thermoplastic resin which has been joined by welding to the foam substrate so as to project from the surface of the foam substrate, by which method a molded article with good appearance having no dimples can be produced.

In one aspect, the present invention provides a method for producing a thermoplastic resin molded article comprising a foam substrate made of a first thermoplastic resin and a functional member made of a second thermoplastic resin which has been joined by welding to the foam substrate so as to project from a surface of the foam substrate, the method comprising the following steps (1) through (6) that are carried out by the use of a molding machine comprising a first mold that has a first molding surface having a recess defining a cavity for forming the functional member therein and that has a resin passage leading to the cavity at a gate that opens in the bottom of the recess and a second mold that has a second molding surface and is arranged with the second molding surface facing the first molding surface:

(1) a step of placing a pressure-resistant sheet on a part of the first molding surface so as to cover a region where an extension line of the gate intersects an imaginary plane surrounded by the first molding surface except for the recess;

(2) a step of supplying a foam substrate made of the first thermoplastic resin to between the first mold on which the pressure-resistant sheet has been placed and the second mold;

(3) a step of closing the molds until a clearance between the first mold and the second mold reaches a predetermined value not greater than the thickness of the foam substrate;

(4) a step of feeding a molten second thermoplastic resin into the cavity through the resin passage until the cavity is filled up with the second thermoplastic resin and the fed second thermoplastic resin comes into contact with the foam substrate and the pressure-resistant sheet while holding the first and second molds at the predetermined clearance;

(5) a step of cooling the second thermoplastic resin to solidify it while holding the first and second molds closed after stopping the feed of the second thermoplastic resin, thereby forming the functional member in the recess and simultaneously forming a thermoplastic resin molded article comprising the functional member and the foam substrate;

(6) a step of opening the molds and taking out the thermoplastic resin molded article.

### BRIEF DESCRIPTION OF THE DRAWINGS

FIG. 1 is a sectional view showing a dimple formed on a molded article's surface corresponding to the portion at which a functional member has been formed.

FIG. 2 is a sectional view of the first mold.

FIG. 3 is another sectional view of the first mold.

FIG. 4 is a diagram showing the outline of the method of the present invention.

FIG. 5 is a diagram illustrating a state that the pressure-resistant sheet has been placed so that it can cover a part of the opening of the recess in the molding surface of the first mold while containing the extended portion of the gate.

FIG. 5(a) is a sectional view perpendicular to the longitudinal direction of the rib and FIG. 5(b) is a sectional view parallel to the longitudinal direction of the rib.

FIG. 6 is a plan view of a thermoplastic resin molded article having a rib.

FIG. 7 is a sectional view of the thermoplastic resin molded article of FIG. 6 taken along line (a).

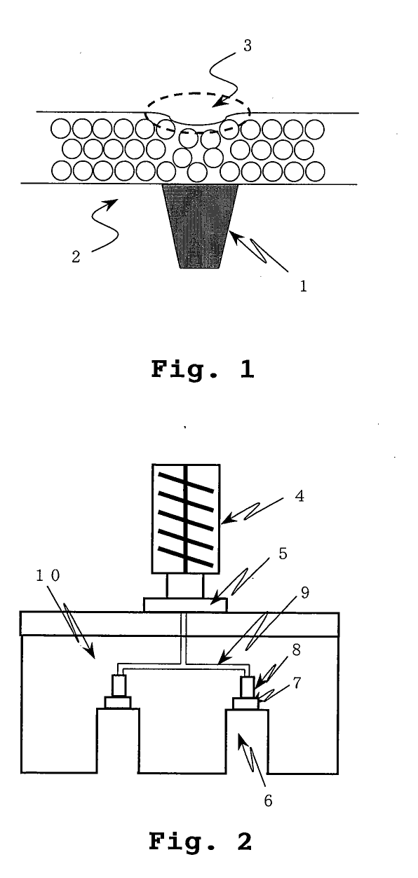

The reference numbers in the drawings respectively have meanings as follows: 1: functional member, 2: thermoplastic resin molded article, 3: dimple on the surface of a molded article, 4: screw-type extruder, 5: nozzle, 6: cavity 7: gate 8: sprue, 9: runner, 10: first mold, 11: width of an opening, 12: width of a bottom, 13: height, 14: pressure-resistant sheet, 15: foam substrate; 16: clamping frame, 17: second mold, 18: rib (functional member), 19: thermoplastic resin molded article, 20: extended portion of gate, and 21: length of a rib.

### MODE FOR CARRYING OUT THE INVENTION

The present invention provides a method for producing a thermoplastic resin molded article comprising a foam substrate made of a first thermoplastic resin and a functional member made of a second thermoplastic resin which has been joined by welding to the foam substrate so as to project from the foam substrate. This method is performed by the use of a molding machine having a first mold that has a first molding surface having a recess defining a cavity for forming a functional member and has a resin passage leading to the cavity at a gate opening at the bottom of the recess and a second mold that has a second molding surface and arranged with the second molding surface facing the first molding surface. In the following description, the first mold and the second mold are sometimes collectively called a pair of molds.

The first and second molds may be various combinations such as a combination of a male mold and a female mold, a combination of two female molds, and a combination of two flat molds. The position where the recess is provided on the molding surface of the first mold, i.e., the first molding surface, and the shape of the recess are not particularly restricted. A mold that has been provided with a recess according to the position and the shape of a functional member to be joined onto a foam substrate can be used. Molded articles to be produced by the method of the present invention may have either one functional member or two or more functional members. When a molded article having one functional member is produced, a first mold having only one cavity for forming the functional member is used. When a molded article having two or more functional members is produced, a first mold having cavities as many as the number of the functional members to be formed is used. While the first and second molds have no particular limitations on their material, they are normally made of metal from the viewpoints of dimensional stability, durability and thermal conductivity. From the cost and weight points of view, the molds are preferably made of aluminum or stainless. Both the molds are preferably structured so that the temperature thereof can be controlled with a heater or heat medium. For preventing the foam substrate from deforming, the molding surfaces of the molds are preferably adjusted within a range of from 20 to 80° C., and more preferably from 30 to 60° C. during the production of a thermoplastic resin molded article. Molds through which vacuum suction or supply of compressed air can be applied may be used. By using, as the first mold, a mold in which vacuum suction can be performed near the recess of the molding surface, it is possible to fix the pressure-resistant sheet to the molding surface by the action of vacuum suction when placing the pressure-resistant sheet as described later.

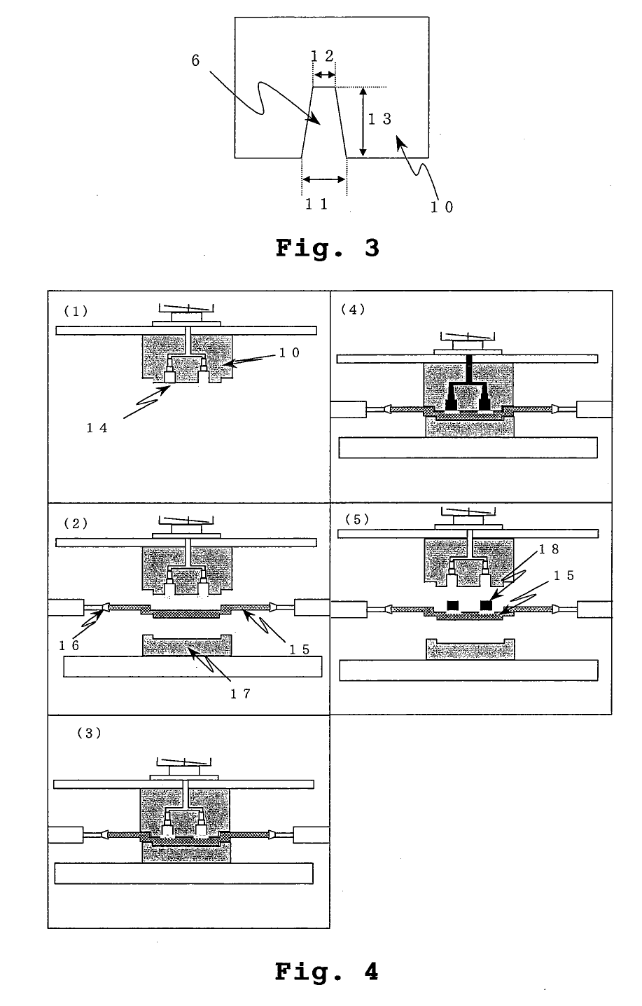

As shown in FIG. 2, the first mold (10) has a resin passage through which a molten thermoplastic resin is introduced into a cavity (6) defined by a recess on the first molding surface and the resin passage is opened at its one end in the recess. In this embodiment, the other end of the passage is connected to a nozzle (5) located at the tip of a screw type extruder (4). The portion (7) where the resin passage is opened in the recess is called “gate” and the gate (7) is located at the bottom of the recess. In the case of a resin passage having a common structure, a molten thermoplastic resin is supplied into the cavity (6) through the gate via a conduit (9) that is called “runner” or a cylindrical cavity (8) that is called “sprue”. When the resin passage is long, it is desirable for the resin passage to be equipped with heating means such as a heater in order to prevent the molten thermoplastic resin from cooling to solidify. One recess may have either one gate or a plurality of gates. When the functional member to be formed in the cavity (6) is a rib, a cross section of the recess defining the cavity (6), which cross section is perpendicular to the longitudinal direction of the recess, is usually in the shape depicted in FIG. 3. The recess defining the cavity (6) is characterized by the opening width (11), the bottom width (12), the height (13), and so on. Because of excellence in releasability from a mold exhibited in molding, the opening width (11) is made approximately 0.1 to 0.5 mm greater than the bottom width (12).

In the present invention, a foam substrate made of a thermoplastic resin is used. Examples of the thermoplastic resin for forming the foam substrate include olefin-based resin such as homopolymers of olefins having from 2 to 6 carbon atoms, e.g. ethylene, propylene, butene, pentene and hexene and olefin copolymer produced by copolymerizing of two or more kinds of monomers selected from olefins having from 2 to 10 carbon atoms, ethylene-vinyl ester copolymer, ethylene-(meth)acrylic acid copolymer, ethylene-(meth)acrylic ester copolymer, ester resin, amide resin, styrenic resin, acrylic resin, acrylonitrile-based resin and ionomer resin. These resins may be used either solely or in a combination of two or more resins. Olefin-based resins are preferably used from the viewpoints of moldability, oil resistance and cost. Propylene-based resins are particularly preferably used from the viewpoint of rigidity and heat resistance of resulting molded articles.

Examples of the propylene-based resins include propylene homopolymers and propylene-based copolymers containing at least 50 mol % of propylene units. The copolymers may be block copolymers, random copolymers and graft copolymers. Examples of the propylene-based copolymers to be suitably employed include copolymers of propylene with ethylene or an α-olefin having 4 to 10 carbon atoms. Examples of the α-olefin having 4 to 10 carbon atoms include 1-butene, 4-methylpentene-1,1-hexene and 1-octene. The content of the monomer units except propylene in the propylene-based copolymer is preferably up to 15 mol % for ethylene and up to 30 mol % for α-olefins having 4 to 10 carbon atoms. The propylene-based resin may be composed of either a single kind of polymer or a mixture of two or more kinds of polymers.

When a long-chain-branching propylene-based resin or a propylene-based resin having a weight average molecular weight of 1×10⁵ or more is used in an amount of 50% by weight or more of the thermoplastic resin forming a foamed layer, it is possible to produce a propylene-based resin foamed substrate containing finer cells. Among such propylene-based resins, non-crosslinked propylene-based resin is suitably used because it will hardly cause gelation during a recycling process.

The foaming agent for use in the preparation of the foamed substrate to be used in the present invention may be either a chemical foaming agent or a physical foaming agent. Moreover, both types of foaming agents may be used together. Examples of the chemical foaming agent include known thermally decomposable compounds such as thermally decomposable foaming agents which form nitrogen gas through their decomposition (e.g., azodicarbonamide, azobisisobutyronitrile, dinitrosopentamethylenetetramine, p-toluenesulfonyl hydrazide, p,p′-oxy-bis(benzensulphonyl hydrazide); and thermally decomposable inorganic foaming agents which form carbon dioxide gas through their decomposition (e.g., sodium hydrogencarbonate, ammonium carbonate and ammonium hydrogencarbonate). Specific examples of the physical foaming agent include propane, butane, water and carbon dioxide gas. Among the foaming agents provided above as examples, water and carbon dioxide gas are suitably employed because foamed substrates will produce less deformation resulting from secondary foaming during the heating in a vacuum forming process and also because those agents are substances inert under high temperature conditions and inert to fire. While the amount of the foaming agent used is properly determined on the basis of the kinds of the foaming agent and resin used so that a desired expansion ratio is achieved, 0.5 to 20 parts by weight of foaming agent is usually used for 100 parts by weight of the thermoplastic resin.

While the method for producing the foam substrate is not particularly restricted, a sheet obtained by extrusion forming using a flat die (T die) or a circular die is desirable. A method is used particularly preferably in which a molten resin is caused to be extruded while being allowed to foam, followed by being stretched and cooled over a mandrel or the like. When producing a foam substrate by extrusion forming, it is also permissible to extrude a molten resin through a die, cool it to solidify, and then perform stretching. While the foam substrate may have either a single layer or a plurality of layers, a multilayer foam substrate having non-foam layers as exterior layers is preferable from the viewpoints of prevention of breakage at the time of manufacturing the substrate. While the resins which have been provided as examples of the resin forming the foam layer can be used as the resin forming the non-foam layer(s), the resin forming the non-foam layer(s) is preferably a resin of a type the same as that of the resin forming the foam layer. For example, when the foam layer is made of a propylene-based resin, it is desirable that the non-foam layer(s) be also made of a propylene-based resin. While the thermoplastic resin foam sheet to be used is not particularly restricted, a foam sheet having an expansion ratio of from 2 to 10 and a thickness of approximately from 1 to 10 mm is usually used.

The foam substrate used in the present invention may have a skin material laminated on a surface thereof. Examples of the skin material include materials that have functions of decoration, improvement in touch feeling, reinforcement or protection. Specific examples include woven fabric, nonwoven fabric, knit fabric, sheet, film, foam and mesh. Examples of materials for forming such skin materials include thermoplastic resins, such as olefin-based resins, vinyl chloride-based resins and styrene-based resins, thermosetting resins, such as urethane-based resins, rubbers and thermoplastic elastomers, such as cis-1,4-polybutadiene and ethylene-propylene copolymers, cellulosic fibers, such as cotton, hemp and bamboo. Such skin materials may have been applied with uneven patterns such as grain pattern, print or dyeing and they may be of either a single layer structure or a multiple layer structure. A skin material in which a cushion layer has been formed in order to add soft feeling can also be used. Lamination of a foam substrate and a skin layer can be performed by dry lamination, sandwich lamination, hot roll lamination, hot air lamination, or the like.

The foam substrate to be used in the present invention may contain additives. Examples of such additives include fillers, antioxidants, light stabilizers, UV absorbers, plasticizers, antistatic agents, colorants, releasing agents, fluidity-imparting agents and lubricants. Specific examples of the filler include inorganic fibers, such as glass fiber and carbon fiber, and inorganic particles, such as talc, clay, silica, titanium oxide, calcium carbonate and magnesium sulfate.

In the present invention, while the thermoplastic resin to be used as the material forming the functional member is not particularly restricted, a resin which exerts good weldability to the thermoplastic resin forming the foam substrate is chosen. A thermoplastic resin which is the same as or similar to the thermoplastic resin forming the foam substrate is preferred from the viewpoint of welding strength to the foam substrate. The thermoplastic resin for the functional member may also include various kinds of additives. Examples of such additives include fillers, antioxidants, light stabilizers, UV absorbers, plasticizers, antistatic agents, colorants, releasing agents, fluidity-imparting agents and lubricants.

The method of the present invention is performed, as described above, by the use of a molding machine having a first mold that has a first molding surface having a recess defining a cavity for forming a functional member and has a resin passage leading to the cavity at a gate opening at the bottom of the recess and a second mold that has a second molding surface and arranged with the second molding surface facing the first molding surface.

The method of the present invention is described with reference to FIG. 4(1) to FIG. 4(5). Step (1) is a step of placing a pressure-resistant sheet (14) on a part of the first molding surface so as to cover a region (20) (shown in FIGS. 5(a) and 5(b)) where an extension line of the gate of the first mold (10) intersects an imaginary plane surrounded by the first molding surface except for the recess as illustrated in FIG. 4(1). In FIG. 4(1), the pressure-resistant sheet has been fixed to the first molding surface with a pressure-sensitive adhesive tape (not shown). Henceforth, the region (20) is sometimes referred to as a gate extension portion.

If a foam substrate is supplied to between the first mold and the second mold without placing any pressure-resistant sheet, then the molds are closed to close the opening of the cavity (6), and then, while this condition is kept, a molten thermoplastic resin is fed to the cavity (6), the foam substrate receives a high resin pressure at the gate elongation portion, so that the foam substrate is compressed to become thinner at the portion. Therefore, when the molten thermoplastic resin cools to solidify, a dimple may be formed on the surface of the foam substrate. By placing a pressure-resistant sheet (14) at a gate extension portion (20) as in the present invention, the pressure-resistant sheet can absorb to some extent the resin pressure or the heat applied when feeding a molten thermoplastic resin and, as a result, the formation of dimples is prevented. In the present invention, a pressure-resistant sheet is placed so that at least a gate extension portion may be covered therewith. Specifically, it is permissible to place a pressure-resistant sheet so as to cover the opening of a recess of the first molding surface entirely therewith. Alternatively, it is also permissible to place a pressure-resistant sheet on a part of the opening of the recess so as to cover the gate extension portion therewith. Since the pressure-resistant sheet will become a part of a thermoplastic resin molded article to be eventually obtained, it is desirable, from the viewpoint of the lightweight property of a molded article to be obtained, to place the pressure-resistant sheet at a part of the opening of the recess. Usually, it is desirable to place the pressure-resistant sheet so as to cover a circular region about 10 mm in radius with center at the gate extension portion.

The thickness of the pressure-resistant sheet is usually from about 0.1 to about 3 mm. In order to eliminate defective appearance of a molded article, a pressure-resistant sheet becomes more desirable with increase in its thickness. If it is excessively thick however, it may become difficult to unite the pressure-resistant sheet and a foam substrate. Therefore, the thickness of the pressure-resistant sheet is desirably up to 70%, more desirably up to 50% of the thickness of the foam substrate.

Generally, a greater effect on appearance improvement is obtained with increase in basis weight (i.e., weight per unit area) of the pressure-resistant sheet. From the viewpoint of the lightweight property of a molded article to be obtained, however, the basis weight of the pressure-resistant sheet is desirably from about 100 to about 1000 g/m².

Examples of the pressure-resistant sheet include woven fabric, nonwoven fabric, knit fabric, nonfoam sheet, foam sheet, etc. Such pressure-resistant sheets are made from thermoplastic resins, such as olefin-based resins, vinyl chloride-based resins and styrene-based resins, rubbers and thermoplastic elastomers, such as polybutadiene and ethylene-propylene copolymers, and cellulosic fibers, such as cotton, hemp and bamboo. From the viewpoint of heat bondability to a foam sheet, the pressure-resistant sheet is desirably made of a resin the same as that of a thermoplastic resin foam sheet. The pressure-resistant sheet may have either a single layer or a plurality of layers. It is also possible to enhance the effect by increasing the rigidity of the pressure-resistant sheet through incorporation of fillers, such as inorganic fine particles, e.g., talc, and metal fine particles.

Step (2) is a step of supplying a foam substrate (15) made of a first thermoplastic resin to between a first mold (10) on which the pressure-resistant sheet has been placed and a second mold (17) as illustrated in FIG. 4(2). In this step, the foam substrate is usually fixed with a clamping frame (16). The foam substrate may have been shaped preliminarily into a desired shape before its supply to between the molds. In the preliminary shaping of foam substrate, the first mold and the second mold may be used. A mold that has a molding surface of the same configuration as that of the molding surface of the first mold except for having no recess may be used instead of the first mold. It is permissible to heat the foam substrate to soften it before its supply to between the molds. In this case, the step (3), which is described later, is preferably performed before the foam substrate loses its softened state suitable for shaping. The method for heating the foam substrate is not particularly limited and it may be a method of heating the foam substrate with a heater or hot air. The heating is performed desirably so that the surface temperature will become the melting temperature (for crystalline resins) or softening temperature (for noncrystalline resins) of the thermoplastic resin forming the foam substrate or higher. In the case of, for example, a foam substrate made of a propylene-based resin, it is desirable to heat so that the surface temperature will become about 180° C. to about 220° C. The temperature of the surface of the foam substrate can be measured by bringing a thermocouple into contact with the surface.

Step (3) is a step of closing the molds until a clearance between the first mold and the second mold reaches a predetermined value not greater than the thickness of the foam substrate supplied in step (2) as shown in FIG. 4(3). The term “thickness of a foam substrate” as used herein means the thickness of the foam substrate under an unloaded condition before the mold closure. The clearance is the distance in the mold closure direction between the molding surfaces of the molds. The mold closing pressure is desirably adjusted to within the range of 1 to 100 ton/m².

Step (4) is a step of feeding a molten thermoplastic resin into the cavity through the resin passage while holding the first and second molds at the predetermined clearance. FIG. 4(4) shows a state where the feed of the thermoplastic resin has been completed. In this step, the thermoplastic resin is fed until the cavity is filled up therewith and the thermoplastic resin comes into contact with the foam substrate and the pressure-resistant sheet. In the case of using a foam substrate that has been softened by being heated, it is desirable that the surface temperature of the foam substrate at the time of supplying a molten thermoplastic resin be as low as allowable. Usually, temperatures not higher than the softening temperature of the thermoplastic resin forming the foam substrate are allowed. For example, for a foam substrate made of a propylene-based resin, the surface temperature is desirably within the range of from 100 to 50° C.

In the case of placing a pressure-resistant sheet so as to cover the opening of a recess of the first molding surface entirely therewith, feeding the molten thermoplastic resin so that it will flow out of the cavity allows the pressure-resistant sheet to be fixed to the foam substrate with the molten thermoplastic resin. In the case of placing a pressure-resistant sheet at a part of the opening of the recess so as to cover the gate extension portion as illustrated in FIG. 5(b), the pressure-resistant sheet may be fixed by feeding a molten thermoplastic resin so that it can flow out of the cavity as in the foregoing. By feeding a molten thermoplastic resin into a cavity, however, the molten thermoplastic resin is joined by welding to the foam substrate at a portion where no pressure-resistant sheet has been placed and at least a part of the pressure-resistant sheet comes into contact with the molten thermoplastic resin and, as a result, the pressure-resistant sheet is fixed. While the amount of resin fed for one gate may be properly set according to the shape of the cavity, or the like, it is desirable about 10 to about 100 g, and more desirably about 20 to about 50 g.

In each of steps (2) to (4), vacuum suction through a molding surface of a mold may be performed or compressed air may be supplied through the molding surface of the second mold. By the execution of such vacuum suction or supply of compressed air, it is possible to attach the pressure-resistant sheet or the foam substrate closely to a molding surface and it thereby is possible to prevent detachment or unintentional displacement of the pressure-resistant sheet or prevent leak of the molten resin to be fed. When vacuum suction is executed, it is desirable to conduct the suction so that the degree of vacuum in the gap between a molding surface and the foam sheet may fall within the range of from −0.05 to −0.1 MPa. The degree of vacuum is the pressure in the gap between the molding surface and the foam substrate expressed on the basis of the atmospheric pressure. That is, “the degree of vacuum is −0.05 MPa” means that the difference between the atmospheric pressure and the pressure in the sucked gap between the foam substrate and the molding surface is 0.05 MPa. The degree of vacuum is detected within a vacuum suction passage provided in a mold. When compressed gas is supply through the molding surface of the second mold, the compressed gas is desirably supplied so that the pressure in the gap between the molding surface and the foam substrate may fall within the range of from 0.05 MPa to 0.7 MPa.

Step (5) is a step of cooling a molten thermoplastic resin to solidify it while holding the first and second molds closed after stopping the feed of the thermoplastic resin as illustrated in FIG. 4(4), thereby forming a functional member in the cavity and simultaneously forming a thermoplastic resin molded article comprising the functional member and the foam substrate.

The thermoplastic resin molded article obtained in step (5) is a molded article in which a functional member formed by cooling of a molten thermoplastic resin in the cavity (6) has been joined by welding to a part of a foam substrate. The functional member in the present invention is a component which has been formed to project from a foamed substrate. Specific examples thereof include a rib, which has a function of reinforcing a thermoplastic resin molded article, or components like a boss, a clip or a hook that have a function of attaching a thermoplastic resin molded article to another object.

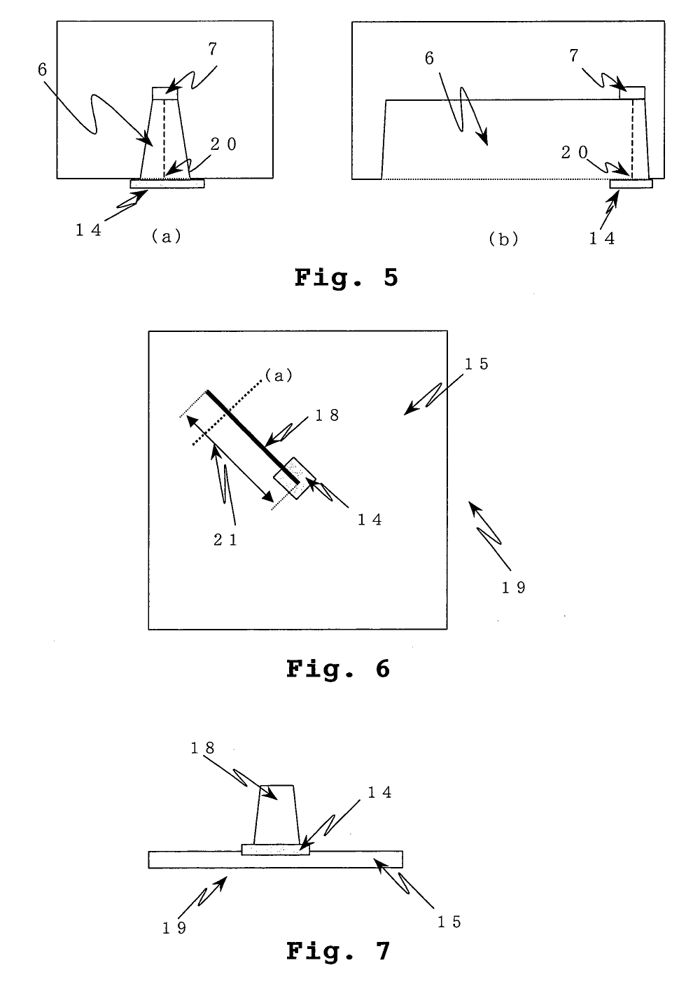

Step (6) is a step of opening the molds and taking out the thermoplastic resin molded article. One example of thermoplastic resin molded articles to be obtained by the method of the present invention is illustrated in FIG. 6 and FIG. 7. In the thermoplastic resin molded article (19), a pressure-resistant sheet (14) is sandwiched between a rib (18), which is a functional member, and a foam substrate (15). In FIG. 7, reference number 21 expresses the length of the rib (18).

The thermoplastic resin molded articles obtained by the present invention can be used for packaging materials, such as food containers, automobile interior components, building materials and household electric appliances. Examples of automobile interior components include door trims, ceiling materials and trunk side trims. For example, when a thermoplastic resin molded article having a rib joined by welding as a functional member is used as an automobile interior component, cars having the interior component becomes high in strength. Thermoplastic resin molded articles having a boss or a hook joined by welding as a functional member can be connected to other automobile constituent components easily.

### EXAMPLES

The present invention is described below with reference to examples, but the invention is not limited to the examples.

The molds used in an example and a comparative example are as follows.

First mold: a mold having, in its molding surface, a recess that defines a cavity for forming a rib of 3 mm in thickness at a root, 2.7 mm in thickness at a top, 5 mm in height and 150 mm in length. A resin passage composed of a sprue, a runner and so on provided in the mold was connected and opened to the bottom of the recess (i.e., the portion corresponding to the top of a rib) via a gate 8 mm in diameter.

Second mold: a mold having a flat molding surface and being capable of vacuum sucking.

### (1) Preparation of a Foam Substrate

A foam substrate was produced by using a polypropylene foam non-crosslinked sheet (commercial name: SUMICELLER, produced by Sumika Plastech Co., Ltd.) having an expansion ratio of 3 and a thickness of 3 mm and a laminate sheet composed of an olefin-based thermoplastic elastomer sheet having a thickness of 0.6 mm and a polypropylene crosslinked foam sheet having an expansion ratio of 10 and a thickness of 2.5 mm (commercial name: VINYLER, produced by Kyowa Leather Cloth Co., Ltd.).

Hot air of a temperature of 250° C. and a flow rate of 15 m/sec was blown from a hot air source to a surface of the polypropylene non-crosslinked foam sheet, thereby melting the surface. The melted polypropylene non-crosslinked foam sheet was superposed on the laminate sheet so as to face the surface of the polypropylene crosslinked foam sheet of the laminate sheet. The sheets were supplied at a line speed of 2.5 m/min to between a pair of rolls having a roll-roll distance of 3 mm and a nipping pressure of 0.05 MPa. Thus, a foam substrate having a thickness of 6.1 mm was produced.

### Example 1

A pressure-resistant sheet made of a propylene-based resin (commercial name: NOBLEN FS2011DG2, produced by Sumitomo Chemical Co., Ltd.) having a thickness of 0.5 mm and a diameter of 20 mm was placed so as to cover the gate extension portion of the first mold.

The foam substrate was fixed to a clamping frame of a vacuum forming machine (commercial name: VAIM0301, manufactured by Sato Tekko Co., Ltd.) and was heated with a near-infrared heater so that the polypropylene non-crosslinked foam sheet surface of the foam substrate would come to have a temperature of 200° C. Thus, the foam substrate was softened. The softened foam substrate had a thickness of 6.3 mm. While the foam substrate was fixed to the clamping frame, it was supplied to between a first mold on which the pressure-resistant sheet had been placed and a second mold so that the polypropylene non-crosslinked foam sheet side might be located on the first mold side. The temperature of the second mold was adjusted at 60° C.

Then the first mold and the second mold were closed until the clearance between their molding surfaces would become 5.5 mm, and vacuum suction at −0.09 MPa was performed through the molding surface of the second mold, thereby shaping the foam substrate. Then the first mold and the second mold were compressed with a compression force of 200 kN and a molten propylene-based resin (polypropylene produced by Sumitomo Chemical Co., Ltd., commercial name: NOBLEN BUE81E6, MFR=80 g/10 min) was then fed into the cavity at a rate of 3 g/sec for 1.1 seconds through the runner and the sprue forming the resin passage provided in the first mold, thereby filling the cavity up with the molten propylene-based resin. After cooling a resulting molded article by blowing air from a cooling fan while holding the molds closed, the molds were opened and the molded article was taken out. Unnecessary edges were cut off, yielding a molded article in which a rib illustrated in FIG. 6 and FIG. 7 had been joined by welding to a flat plate (the foam substrate). There was no dimple on the resulting molded article's surface corresponding to the portion of the article where the rib was formed and, therefore, the molded article had good appearance.

### Comparative Example 1

A molded article was produced in the same manner as Example 1 except for placing no pressure-resistant sheet at the gate extension portion of the first mold. A dimple was found on the resulting molded article's surface corresponding to the portion of the article where the rib was formed.

### INDUSTRIAL APPLICABILITY

According to the method of the present invention, it is possible to obtain a molded article with good appearance having no dimple on the surface opposite to a foam substrate's portion where a functional member has been joined by welding.

1. A method for producing a thermoplastic resin molded article comprising a foam substrate made of a first thermoplastic resin and a functional member made of a second thermoplastic resin which has been joined by welding to the foam substrate so as to project from a surface of the foam substrate, the method comprising the following steps (1) through (6) that are carried out by the use of a molding machine comprising a first mold that has a first molding surface having a recess defining a cavity for forming the functional member therein and that has a resin passage leading to the cavity at a gate that opens in the bottom of the recess and a second mold that has a second molding surface and is arranged with the second molding surface facing the first molding surface:
(1) a step of placing a pressure-resistant sheet on a part of the first molding surface so as to cover a region where an extension line of the gate intersects an imaginary plane surrounded by the first molding surface except for the recess;
(2) a step of supplying a foam substrate made of the first thermoplastic resin to between the first mold on which the pressure-resistant sheet has been placed and the second mold;
(3) a step of closing the molds until a clearance between the first mold and the second mold reaches a predetermined value not greater than the thickness of the foam substrate;
(4) a step of feeding a molten second thermoplastic resin into the cavity through the resin passage until the cavity is filled up with the second thermoplastic resin and the fed second thermoplastic resin comes into contact with the foam substrate and the pressure-resistant sheet while holding the first and second molds at the predetermined clearance;
(5) a step of cooling the second thermoplastic resin to solidify it while holding the first and second molds closed after stopping the feed of the second thermoplastic resin, thereby forming the functional member in the cavity and simultaneously forming a thermoplastic resin molded article comprising the functional member and the foam substrate;
(6) a step of opening the molds and taking out the thermoplastic resin molded article.
